(19) United States
(12) Patent Application Publication
(10) Pub. No.: US 2019/0213573 A1
(43) Pub. Date: Jul. 11, 2019

(54) SYSTEMS AND METHODS FOR PROCESSING STORE RETURNS

(71) Applicant: Walmart Apollo, LLC, Bentonville, AR (US)

(72) Inventors: Tyler Zelten, Centerton, AR (US); Rebecca Engelke, Rocky Comfort, MO (US); Robert Cantrell, Herndon, VA (US); John J. O'Brien, V, Bella Vista, AR (US); Brian Gerard McHale, Chadderton (GB); Bruce Wilkinson, Rogers, AR (US); Donald R. High, Noel, MO (US); Todd Mattingly, Bentonville, AR (US)

(21) Appl. No.: 16/215,786

(22) Filed: Dec. 11, 2018

Related U.S. Application Data
(60) Provisional application No. 62/615,556, filed on Jan. 10, 2018.

(51) Int. Cl. G06Q 20/20; G06Q 30/00

(52) U.S. Cl. CPC G06Q 20/209; G06Q 30/0224; G06Q 30/016

(57) ABSTRACT

A method for processing store returns, comprising: selecting, from a data repository, an electronically archived purchase receipt corresponding to an item for return to a retail establishment; identifying the retail establishment for returning the purchased item regardless of whether the item was purchased at the retail establishment; associating at the data repository the purchase receipt and a selected type of tender; and electronically and automatically transferring a refund for the returned item to the selected type of tender.

### CROSS REFERENCE TO RELATED APPLICATION

This invention claims priority to U.S. provisional patent application Ser. No. 62/615,556, filed Jan. 10, 2018, and entitled “Systems and Methods for Processing Store Returns”, which is incorporated entirely herein by reference.

### FIELD OF THE DISCLOSURE

The present disclosure relates generally to store returns, and more specifically to systems and methods for archiving purchase receipts for use in future store returns.

### BACKGROUND

Modern day consumers have a variety of options with respect to purchasing items or services of interest, for example, an e-commerce website or marketplace, neighbourhood stores, superstores, auctions, and so on. Regardless of the source of purchase, a receipt or other proof of purchase is typically required to confirm ownership of an item when a consumer attempts to return the item, for example, an item under warranty, a defective item, and so on.

### SUMMARY

In one aspect, provided is a method for processing store returns, comprising: determining where the item was purchased; accessing the receipt; and returning an item at a store regardless of whether the item was purchased at the store.

In another aspect, provided is a method for processing store returns, comprising: selecting, from a data repository, an electronically archived purchase receipt corresponding to an item for return to a retail establishment; identifying the retail establishment for returning the purchased item regardless of whether the item was purchased at the retail establishment; associating at the data repository the purchase receipt and a selected type of tender; and electronically and automatically transferring a refund for the returned item to the selected type of tender.

In some embodiments, the type of tender includes an electronic gift card. In some embodiments, the selected electronically archived purchase receipt is automatically processed to generate a credit that is directly applied to the electronic gift card.

In some embodiments, in response to identifying the retail establishment for returning the purchased item, determining whether to process the item for return at a location of the retail establishment or to pre-process the item prior to returning the item for return.

In some embodiments, the electronically archived purchase receipt is selected among a plurality of purchase receipts corresponding to item purchases made at one or more different retail establishments, and wherein the plurality of purchase receipts are linked at the data repository to a single customer account, and wherein each item purchase includes a purchase receipt uploaded to the single customer account. In some embodiments, the refund includes a credit that is applied to the customer account.

In some embodiments, the data repository includes a customer electronic device interface for displaying return information on a customer computing device. In some embodiments, the return information includes a listing of purchase receipts that includes the archived purchase receipt, which is selected from a user interface of the customer computing device.

In some embodiments, the data repository includes a store-specific return queue for storing a listing of returns predicted for receipt at the retail establishment during a predetermined period of time, which is accessible by a store associate computing device.

In some embodiments, the method further comprises tracking the item for return as the item transitions from a shipping resource to the identified retail establishment.

In some embodiments, the method further comprises identifying a storage locker for the item for return; detecting by a sensor at the storage locker the presence of the item for return; and automatically transferring the refund for the returned item to the selected type of tender in response to detecting the presence of the item for return at the storage locker.

In some embodiments, the method further comprises securing data exchanged between the data repository and a user computing device by executing a peer-to-peer authentication system that generates a blockchain for the data.

In some embodiments, the item for return includes an item purchased at the retail establishment but left behind at the retail establishment, and wherein the method further comprises proving an option of returning or retrieving the item left behind at the retail establishment.

In some embodiments, the data repository stores a record that includes the electronically archived purchase receipt and a recall notification corresponding to the item.

In another aspect, provided is a method for archiving purchase receipts, comprising: purchasing an item; generating an electronic record of the purchased item including a purchase receipt; adding the electronic record to a customer account; adding the purchase receipt to a plurality of electronically archived purchase receipts; and processing a return of the item by subsequently selecting the purchase receipt from the plurality of electronically archived purchase receipts.

In another aspect, provided is a system for returning store items comprising: a data repository; an automated store item return system that archives shopping receipts at the data repository for use for future customer-initiated returns of store items, consolidates store purchase data into a single customer account, the store purchase data include receipts for the store purchases and the type of purchase payment, and includes an interface for a user computing device to access the receipts from the customer account and generate a credit for a returned purchased item based on the accessed receipts; and an authentication system that secures the accessed receipts exchanged between the user computing device and the automated store item return system.

### BRIEF DESCRIPTION OF THE DRAWINGS

Exemplary embodiments will now be described, by way of example only, with reference to the following drawings, in which:

FIG. 1 is a network diagram of an environment in which embodiments of the present inventive concepts can be practiced.

FIG. 2 is a block diagram of an automated store return system, in accordance with some embodiments.

FIG. 3 is a flow diagram of a method for a customer-initiated return of a store item, in accordance with some embodiments.

FIG. 4 is a flow diagram of a store returns process, in accordance with some embodiments.

FIG. 5 is a flow diagram of a method for processing recall notifications, in accordance with some embodiments.

FIG. 6 is a flow diagram of a method for processing missed coupons, in accordance with some embodiments.

FIG. 7 is a flow diagram of a method for processing a return corresponding to a purchased item left behind at a store, in accordance with some embodiments.

FIG. 8 depicts a blockchain and two exemplary blocks of the blockchain, in accordance with some embodiments.

FIG. 9 is a flow diagram illustrating an operation that includes an authentication system implementing a blockchain, in accordance with some embodiments.

### DETAILED DESCRIPTION

Retail establishments ranging from a neighbourhood convenience store to a large department store to a superstore typically offer a means by which a consumer may return an item purchased at the retail establishment. On occasion, a store may experience an unusual number of returns of a particular item due to product defects or damage, or due to the timing of the returns for example, the day after Christmas. Such anomalies place a strain on the store's resources such as sales clerks who service frustrated or impatient customers waiting in long lines or travel long distances to return an item, or customers do not have the original purchase receipt when attempting to return an item, or must work through computer glitches that cause scanning devices to fail, and so on. Yet other customers may purchase items from a website or electronic marketplace, online auction, or other internet location where vendors can sell products, and would like to return the item at a neighbourhood store or other retail establishment within a desired proximity of the customer. For example, a customer may purchase a set of tires from the manufacturer's website, but desire to return the tires to a marketplace. However, in this example, the marketplace may have no desire for the tires because of lack of interest or fear of losing money for accepting the unpopular tires.

To address and overcome the foregoing, embodiments of the present inventive concept include a system and method that archives purchase receipts for future customer-initiated returns of products corresponding to the purchase receipts. Computer users may purchase items with flexibility and not be limited to the same portal, website, or online utility for both purchasing items and returning those purchased items, and therefore, the system and method can consolidate store returns regardless of online purchases or physical (brick-and-mortar) in-store purchases. To accomplish this, the system and method processes and stores data collected from both consumers and store representatives. This data may be used for producing statistical data to be used by either the consumer or the store associate. The returns system and method may therefore permit the consumer to return an item at a different store than the store or e-commerce website where the item was purchased. The store associate on the other hand can assist the consumer with the return even though the item for return was not purchased at the store.

In some embodiments, the system can coexist with, and communicate with, an existing computing system that processes electronic gift (eGift) cards or the like, for example, in an e-commerce transaction. Such systems may compare the price that a purchaser paid for a particular item against those of predetermined competitors, and generates an eGift card, coupon, discount, or the like that provides the purchaser with the difference between the two prices. In these embodiments, an automated return process is executed, whereby the return amount (the difference) is automatically credited to a conventional eGift card or the like, and the purchaser may use an application executed on a smartphone or other personal computing device such as a customer mobile device to select an “in store return” to identify where the purchaser desires to return the purchased item, for example, a store where the purchase wishes shop and process the return at the store. For example, a customer may opt into a program executed by the customer's device, which displays a request for the customer to enter an email address or other identifier during a store checkout process. This information may be used to link a credit or debit card or other payment source to a store account or other location where the customer is associated. The system here stores the transaction receipt in a database, whereby the customer can subsequently review any and all receipts electronically that includes a record of the item that the customer wishes to return. Returns that are completed through the application and finalized either at the store or at a locker kiosk or the like may credit the customer's eGift Card that is linked to the account, for example, similar to a system that automatically processes a savings-related determination to a linked eGift card.

During an operation, when a store customer completes a purchase transaction, for example, at a checkout counter, an e-commerce website, or a marketplace vendor, the returns system may request that the customer enter into a computer a phone number, account number, or other identification. The system may use this information to combine store purchases under a single account, which includes purchase receipts, payment details, customer information, and so on, is stored at an accessible data repository. For example, the customer can provide this information to the system which in response may retrieve all sales associated with the account. Each sale will upload a receipt to the customer's account, where a record is stored that includes the purchase receipt and/or other relevant information regarding the purchased item, such as recall notifications, warranty data, and so on. Other relevant information may also be provided such as the type of tender used, so that a return may be credited against the correct form of tender.

The customer's personal computer such as a smartphone, computer tablet, or the like may store and execute a software application that performs operations described herein. For example, the application may include a returns feature that electronically retrieves data related to returns, for example, purchase receipts, which may be used to process or pre-process returns. The returns system may be configured to inform the customer where to complete a physical return of an item, or information where to ship an item for return. The returns application may allow a customer who is planning to return a product in a store to pre-process the return and thus efficiently and quickly perform a return process once in the store. The arrangement of the display data on a user interface of a computer display is performed with other computer-based elements in communication via a network to allow the returns application when executed to display data allowing a customer to track a product through the returns process as the product transitions from shipping resource such as a delivery truck and so on to the designated retail establishment, or a related facility such as a warehouse, which may include the process of verifying the product and crediting the account. Also, this arrangement allows customers to purchase items in any manner whether online or at a brick-and-mortar store, but adds flexibility where the customers may wish to return the items.

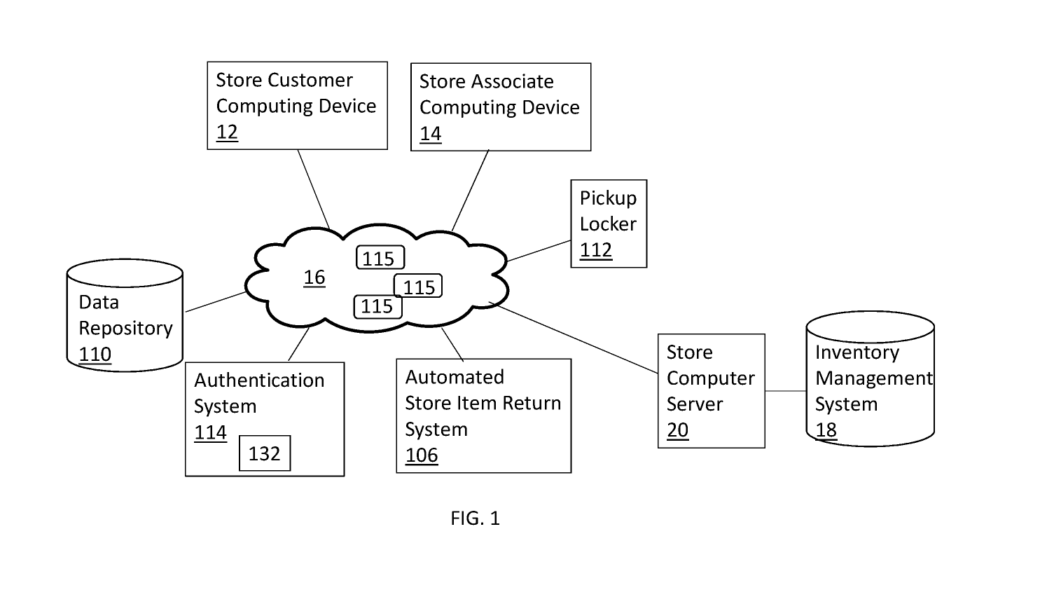

FIG. 1 is a network diagram of an environment in which embodiments of the present inventive concepts can be practiced. The environment may include but not be limited to an automated store item return system 106, a data repository 110, a pickup locker 112, and an authentication system 114. Each of the automated store item return system 106, data repository 110, pickup locker 112, and authentication system 114 has a network interface such as an input/output connection to a network 16. In some embodiments, some or all of these elements of the environment are part of a same computer hardware platform. Some or all of the elements of the environment may be cloud-based, while other elements are resident at and managed by a store, customer, and/or other entity. In other embodiments as shown in FIG. 1, these elements are located on two or more different computer hardware platforms, and can communicate with each other and/or other elements of the environment via a communication network (not shown), for example, wired or wireless network 16 that exchanges data electronically between the automated store item return system 106, data repository 110, pickup locker processing system 112, and authentication system 114, as well as between customer mobile devices 12, store associate mobile devices 14, and/or store computer server 20.

A general feature of the automated store item return system 106 is to archive purchase receipts for future customer-initiated returns so that a purchaser of an item can return the item to a different entity, or location of the entity than that from where the item was originally acquired.

The data repository 110 is constructed and arranged to store customer purchase data including receipts, authorization data, and/or related return data generated and/or processed by one or more of the automated store item return system 106, data repository 110, pickup locker processing system 112, authentication system 114, store customer computing device 12, store associate computing device 4, and/or store computer server 20 of the environment in FIG. 1. In some embodiments, the data repository 110 may include a mobile customer portal 122. The customer portal 122 may include an interface that the customer may view from a customer side of the application. For example, the customer may view “My Receipts,” “Messages/Alerts Inbox,” and “Add My Coupons” buttons displayed at the user interface, in addition to a button, window, or other display region for simplifying a return of items regardless of purchase origin. This may also display a current store that is selected the default store that the customer designates as the location where to process returns, regardless of the location of purchase of the items for return. The data repository 110 may be a standalone database that provides the function of storing customer account data that includes receipt information that can subsequently be accessed by a customer. Alternatively, the data repository 110 may be part of a store computer 20, for example, a POS system or the like. The archiving by the data repository 110 of purchase receipts is useful in situations where the customer brings a product to the store for return but does not have proof of purchase. The data repository 110 in connection with the authentication system 114 may store a data record that includes the purchase receipt, customer credit card information, identification data, and so on to allow the item to be returned in a secure manner, i.e., reducing the risk of fraudulent return. In particular, the authentication system 114 can operate to store data on a secure distributed computing system that includes the data repository 110.

In some embodiments, the data repository 110 is constructed and arranged according to customer-facing, or customer side, features and store employee-facing, or associate side, features. The customer side region of the data repository 110 includes a receipt repository, for example, described herein. In addition, the system includes a message or alert system that communicates with the receipt repository to perform a function where messages, alerts, or related electronic communications are generated and output to the store customer computing device 12 from the store computer server 20 and/or automated store item return system 106 to notify the customer about product recalls, merchandise inadvertently left at the store after purchase, special events offered by the store, such as free flu shots or fund raisers, and so on.

The customer side features may include an “Add My Coupons” icon, button or the like displayed on the store associate computing device for further interacting with the data repository 110. Here, the customer may select a transaction processed during a predetermined period, for example, within the past 48 hours to add a coupon. The customer may select the transaction and scan any coupons using a camera feature of the customer computing device 12. According to this process, upon validation, the customer's electronic gift Card or other savings element on file may be credited with the savings identified by the coupon.

The associate side features of the data repository 110 may include a store-specific return queue that stores data related to returns anticipated for receipt by the store within a predetermined period, for example, over the next 24 hours. The system may provide a “forgotten bag feature,” which allows the associate to enter into the store associate computing device 14 information on bag contents, register number, and time found, which is used to compare against the contents of the data repository 110, for example, account information, so that a message may be generated and output to the customer's account that a bag has been left behind at the store and/or other pertinent information.

The data repository 110 may store recall notification data entered from any of the elements of the environment illustrated in FIG. 1. For example, a store associate from the store computer server 20 and/or store associate computing device 14 may enter recalled item information. An application may then alert users who purchased that item during the designated time frame using the stored information in the data repository 110. Depending on the specifics of the return, the customer can either return the items to the store using the return application if the items need to be brought back to the store or the customer can acknowledge the return accept the refund via the return tool and dispose of those items at the customer's home or designated location, thereby negating the need to return to the store.

Another feature includes to a Pickup/Return locker fill status, where the current status of a locker, e.g., filled or empty, may include a designation of “pickup” or “return” to prompt the associate, e.g., by outputting a message to the associate computing device 14 that the lockers have a predetermined amount of available space for receiving store returns, and need to have the returns physically removed to provide room for new returns or additional pickup orders.

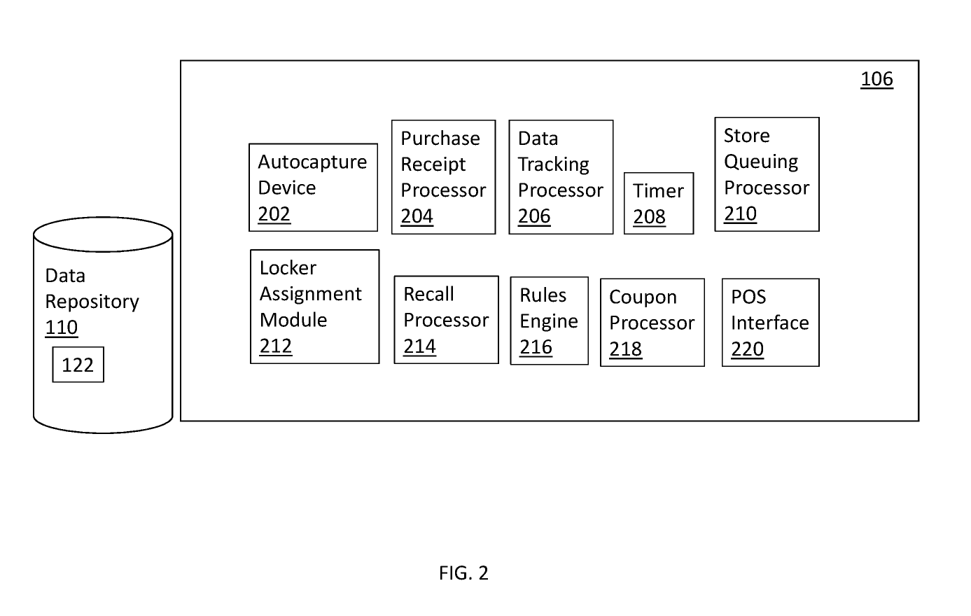

As shown in FIG. 2, the automated store item return system 106 may include an autocapture device 202, a purchase receipt processor 204, a data tracking processor 206 including a “product tracker,” a timer 208, a store queuing processor 210, a locker assignment module 212, a recall processor 214, a rules engine 216, a coupon processor 218, and a point of sale (POS) interface 220. Some or all of these components 202-220 of the automated store item return system 106 may be part of a store computer 20, which performs POS functions and/or other operations related to an item return or exchange. In some embodiments, some or all of these components of the automated store item return system 106 may be part of a same computer hardware platform, or different computer hardware platforms. Some or all of the elements of the environment may be cloud-based, while other elements are resident at and managed by a store, customer, and/or other entity.

The autocapture device 202 receives an output produced by a scanning device that scans a barcode, QR code, or other identifier of an item of interest. When an item for purchase is scanned, for example, at a checkout counter, by a mobile point of sale (POS) scanning device, or by an e-commerce electronic receipt, the scan result can be output to and processed by the autocapture device 202, for example, a point of sale (POS) scanner, for item tracking purposes, for example, added to a data record, e.g., an archived receipt record, stored at the data repository 110 with other relevant data such as a purchase receipt, customer credit card information, and so on for allowing a customer to return an item corresponding to the scan result without producing a physical purchase receipt.

In addition, or alternatively, the POS interface 220 may receive and process item purchase information, such as a purchase receipt, which may in turn be stored as part of an archived receipt record.

The purchase receipt processor 204 receives store receipts, for example, an electronic copy of a purchase receipt from the POS interface 220 after a customer purchases an item of interest and outputs the purchase receipt, including details on the transaction, to the data repository 110. The purchase receipt processor 204 can generate and output electronic data requests to a store computer server 20, database, and/or other repository where customer purchase data is stored, and combine customer purchases under a single account, which in turn can be stored at the data repository 110. In some embodiments, the customer account data is stored externally from the automated store item return system 106 and/or data repository 110, for example, at a separate database controlled by the store computer 20.

In some embodiments, the purchase receipt processor 204 can pre-process returns. For example, a customer who plans to return a store item may complete a questionnaire, submit a return request form, and so on in advance of being physically present in the store to return the item.

The purchase receipt processor 204 can form or otherwise populate archived receipt records for storage at the data repository 110. For example, item return request information may be added to a record that includes a purchase receipt, customer information, type of purchase made (i.e., online purchase, marketplace vendor, point of sale purchase at a store checkout counter, and so on), location of item (e.g., where the item was purchased, where the item was delivered to the customer, a current location of the item, and so on). Therefore, the record may include relevant information, for example, where the sale was facilitated, which is useful in archiving purchase receipts for future customer-initiated returns so that a purchaser of an item can return the item to a different entity, or location of the entity than that from where the item was originally acquired.

The purchase receipt processor 204 may process other relevant information such as the type of tender used to make the purchase, for example, cash, gift card, credit card, bank account, and so on, so that a return may be credited against the correct form of tender.

The data tracking processor 206 may track a product through the returns process as the product transitions from shipper to facility. In doing so, the data tracking processor 206 via the network 16 may communicate with the shipper's tracking database to retrieve the tracking information corresponding to identified items for return, for example, a scan result processed by the autocapture device 202, or other data source that collects purchase data related to the identified items for return. Thus, the data tracking processor 206 can determine where a purchase of an item identified for return is facilitated, which may be used to determine a location for returning the item, which may or may not be different than the store where the item was purchased. For example, a location of the customer's computing device 12 may be tracked using GPS data, WiFi signals, or the like to determine the location of the device 12 relative to stores within proximity of the customer. This data may be used by the system to recommend a return location.

The timer 208 allows the system to establish an allotted amount of time during which the customer may return an item to a store. For example, the timer 208 may be activated when the user completes an online return request form, or completes a telephone call with a customer service agent who activates the timer 208, or upon the completion of a particular action that triggers the timer. If the allotted amount of time exceeds the predetermined time period, for example, 24 hours, then the return request expires. The timer 208 may be configured to include a buffer, for example, extended by a predetermined number of minutes in response to the system determining that the customer is in traffic in an attempt to return the identified returned item to the store. This data may be received and processed by the rules engine 216 and/or data tracking processor 206, which outputs a result to the timer 208 with such time-related information.

The store queuing processor 210 includes at least one queue. One queue may include a list of store locations where items may be returned. The list of store locations may be arranged in the queue according to the store where purchases were made, followed by a listing of other stores where the item may be returned according to distance, size, store hours, and/or other criteria. Another queue may include a listing of items identified for return, for example, items for return can be added after a customer makes a request via computer or telephone to return a particular item. The return system may communicate with a POS system, for example, for use at a checkout counter, to list purchases at the store over a predetermined period of time, for example, the past 24 hours. This data may be used to anticipate potential returns of some of those purchased items.

The locker assignment module 212 assigns a repository such as a kiosk, locker, or other storage location that allows a customer to return a store item without human involvement, such as a store representative at a customer service desk. Computer-based kiosks or the like, on the other hand, may identify return locations without specificity or automation. To address this, the locker assignment module 212 of the automated store item return system 106 may assign a locker or related storage space to the customer based on item file specifications and prompts for a type of return such as gift card, online purchase, cash payment, and so on. The pickup locker 112 may be automatically opened, closed, or locked based on signals received by the locker assignment module 212.

The recall processor 214 processes recall data and reconciles the recall data with identified items for return. For example, receives from or accesses the archived receipt database item transaction data generated in response to the received item number(s) and generates an electronic communication such as a text or email message to customers targeted for receiving recall notifications or the like. For example, a product vendor may send recall information to the store, which records the recall information, which can be retrieved by the recall processor 214. This recall information may be added to an archived receipt record, for example, stored at or otherwise linked with the customer account. The recall processor 214 can retrieve all records includes such recall information so that automatic messages can be sent to customers, i.e., e-mail messages, text messages, traditional mail to a home address, or any other communication identified in the customer information portion of the records.

The rules engine 216 determines whether a store of interest to a customer can accept a returned item, regardless of whether the item was purchased at the store. In some embodiments, the rules engine 216 can perform a “savings catcher” operation, where the rules engine 216 receives an input indicating a price paid by a customer for an item, which can be received from the purchase receipt processor 204 or archived receipt stored at the data repository 110, and compared with competitor prices, which may be retrieved from a remote server, advertising computer, and so on. The rules engine 216 can determine the difference according to a predetermined set of rules, for example, within a predetermined period of time, a threshold difference, and so on. The calculated difference, which may be adjusted by the rules engine 216 according to predetermined criteria, may be used to generate a gift card, or add the difference to a gift card, which may be provided to the customer.

The coupon processor 218 may receive and process coupon barcode data received from the autocapture device 202 or directly from a barcode scanner or the like, and add this data to an archived receipt stored as an electronic record at the data repository 110. The coupon processor 218 may add discount data or other coupon data to an electronic fund account, such as a gift card, debit card, and so on.

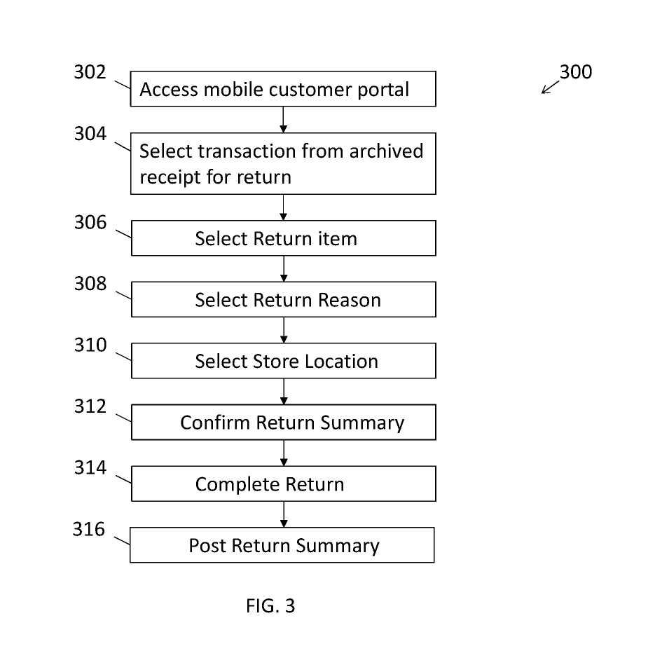

FIG. 3 is a flow diagram of a method 300 for a customer initiated return of a store item, in accordance with some embodiments. In describing the method 300, reference is also made to elements of FIGS. 1 and 2. For example, some or all of the method 300 can be governed by instructions that are stored in a computer hardware memory and can be executed by a computer hardware processor of one or more elements of the environment of FIG. 1.

At block 302, a customer can use a customer computing device 102 such as a smartphone, personal computer, and so on to access the mobile customer portal 122, which includes a database or the like that electronically archives data related to purchase receipts corresponding to items purchased by the customer.

At block 304, a transaction from the archived receipts is selected. The customer may use the computing device 12 to access the receipt in a receipt repository. In some embodiments, the customer computing device 12 communicates with the receipt repository to receive at its user interface a listing of archived receipts linked to the customer account, but not limited thereto. Other information may be displayed such as coupon information, return-related messages or alerts, and so on.

At block 306, a return item can be selected from a displayed listing, or entered by a user. After selecting the transaction, the items on that transaction may be displayed with a quantity number next to each item based on the number of items purchased. After selecting the desired quantities of the items the customer wishes to return the customer may scroll to the bottom and the display screen and select a next item.

At block 308, a reason for returning the item can be selected from a displayed listing, or entered by a user. The customer may select this from a display window generated by the computing device 12, which displays a request for a reason for returning an item. If none of the selectable options are the reason why an item is being returned, then a text box at the bottom of the window may be used to enter a description. Upon completing the customer initiated return on their device 12 the customer will be given a return authorization number generated by the system that can be used at the return location. The information may be output to the store computer server 20 where it may await the arrival of the customer in the store's queue.

At block 310, a store location for bringing the returned item is selected. Here, the selected store location may be different than the store where the item was acquired. In blocks 304-310, the entered result may be processed by the automated store item return system 106

At block 312, the return request is confirmed. A summary of the return can be generated and output to the customer computing device 12.

At block 314, the timer 208 is activated when the customer receives approval to return the selected item at the selected location. The item must be returned to the selected location within a predetermined amount of time. The timer 208 can be user-configured to adjust this amount of allotted time, for example, 24 hours. The timer 208 may be activated when the user completes an online return request form, and the duration of time may be established from this time of activation. If the allotted amount of time exceeds the predetermined time period, for example, 24 hours, then the return request expires.

The store queuing processor 210 may provide a window at a POS system that temporarily holds the customer initiated in-store return information so that there is no need to look up a customer's information and no need for a receipt. The store queuing processor 210 may inform the store computer server 20 that in the next 24 hours, the identified customer will is expected to return particular items, i.e., items selected for return by the customer. At the time of return, the customer may walk up to the customer service counter and provide an identification, e.g., name or return authorization number assigned by the application to the store associate along with the items they selected to return. The associate would then select the customer in the queue and finalize the return.

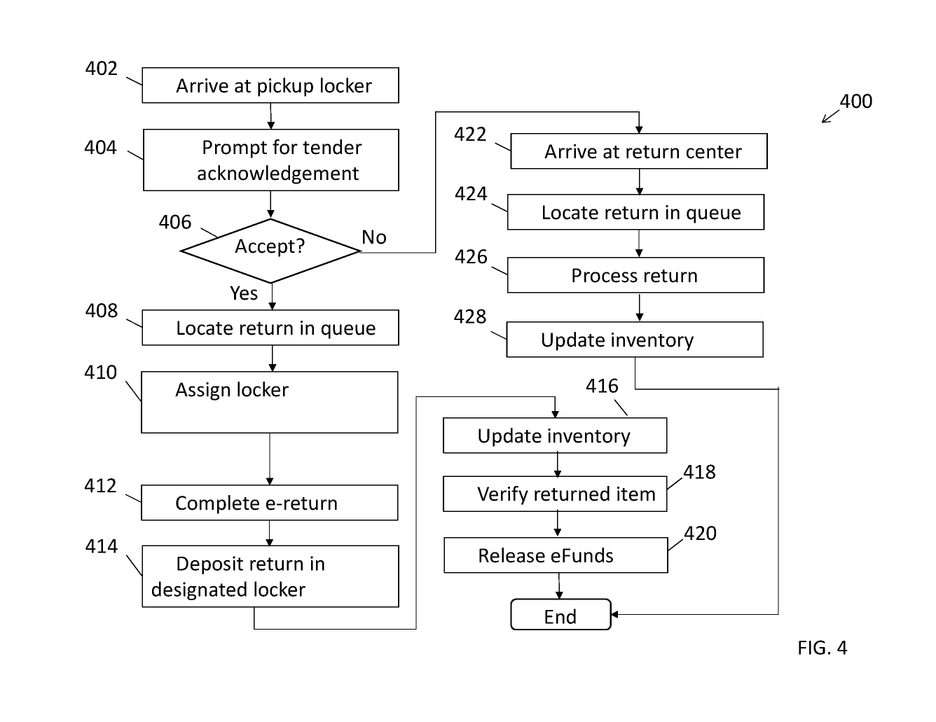

FIG. 4 is a flow diagram of a method 400 for processing store returns process, in accordance with some embodiments. In describing the method 400, reference is also made to elements of FIGS. 1 and 2. For example, some or all of the method 400 can be governed by instructions that are stored in a computer hardware memory and can be executed by a computer hardware processor of one or more elements of the environment of FIG. 1.

At block 402, the customer arrives at a pickup locker. The pickup locker may be a repository such as a kiosk, locker, or other location that allows a customer to return a store item without human involvement, such as a store representative at a customer service desk. Accordingly, the customer can bypass a conventional customer service desk, and therefore, there is no need to enter the store to return the item. The locker systems may include sensors to verify there is something in the locker, for example, weight scales or the like to cross-reference a weight of the items in the locker to the item specifications stored in the data repository 110, cameras to capture images of the items in the locker which could be displayed on the associate side application for quick confirmation of the items, and so on. A store representative may subsequently retrieve the returned item from the pickup locker. The pickup locker processing system 212 may process data related to store items returned to a pickup locker 112, and to automate a confirmation of items delivered into the locker. The pickup locker 112 may have sensors, computer processors, and so on for communicating with the pickup processor 212, for example, to send a confirmation that an item has been placed in the locker 112.

At block 404, the automated store item return system 106 generates a request for a tender acknowledgement, which is output and displayed at the store customer computing device 12. For example, a tender acknowledgement may include a prompt that is displayed on the computing device 12 to inform the customer of a set of tender options available for a given return and further require the customer to select the type of tender they wish to receive, for example, return to credit/debit card, account credit on eGift Card linked to the customer account, or cash dispensed inside at customer service counter.

At decision diamond 406, a determination is made by the user of the store customer computing device 12 whether to accept the tender acknowledgement. If the customer accepts, then the store returns process proceeds to block 408, where the automated store item return system 106 locates the return in the queue 210, also referred to as a store queuing system. The queuing system may be controlled and managed by the queuing processor 210, which may provide a window at a POS computer terminal or the like that temporarily holds the customer initiated return information. The information in the queue may include store receipt details such as a product code (UPC), item description, quantity, and price) in addition to a customer identifier such as customer's name. Items are added to the queue when a customer starts a return on the customer computing device 12 and selects the store as a preferred return location. Upon completing the initiation of the return on their computer 12 the return information is then sent to that store's specific queue for easy lookup and finalization of the return transaction. The queue will only hold that information for a predetermined period, for example, 24 hours, to prevent the system from suffering performance issues due to return records that have not been completed in the 24 hour window such as if customers change their minds and do not cancel the return. The system itself may hold the information for a different amount of time, for example, 28 hours, to allow for some carryover time in case the customer arrives beyond the predetermined time.

At block 410, a locker assignment is generated for placing the returned item. The locker assignment module 212 of the automated store item return system 106 assigns a locker to the customer based on item file specifications and prompts for a return method, for example, via an assigned locker identified by a kiosk or other store computer, or a customer service desk for associate assisted return. In embodiments, where the return method includes a locker or the like, the system assigns the customer a locker number to place their items in. Once the customer places the items in the locker, the locker may include an electronic lock that activates to protect the items from theft or inadvertent misplacement by an unauthorized store associate. This example of a return method may rely on the original form of tender used to purchase the items to be returned. If the original form of tender, e.g., physical gift card or cash, cannot be executed, then the customer will be offered an account credit on the eGift Card linked to the customer's store account. If the customer wishes to be refunded a different form of tender such as cash, then the customer will be prompted to complete the return inside the store for a cash refund. In some embodiments, the customer is provided an option of accepting a proposed locker assignment. Here, the customer may receive a display including a listing the locker numbers for the customer to deposit the items into. Upon selecting a number associated with an available locker, the electronic lock may unlock allowing the customer to place the items in the selected locker or storage location or the like.

At block 412, after a locker or related storage container is assigned, the locker assignment module 212 of the automated store item return system 106 notifies the backend POS system and/or other system required for processing the return, which can finalize an electronic return with a digital receipt confirmation.

At block 414, the customer deposits the item for return into the designated locker.

At block 416, the inventory in the inventory management system 19 of the store computer server 20 is updated with the return item. The returned items may be validated by electronic sensors on the lockers, for example, cameras, weight sensors, and so on. Alternatively, the items are manually verified, e.g., by visual observation.

At block 418, a store associate can pull items at designated times and verify their contents. For example, based on received traffic and usage data, a set time or routine may be established in order to empty out the lockers containing returned inventory so that the lockers can continue to be utilized without reaching maximum capacity and forcing the customer to complete a return inside the store.

At block 420, electronic funds, or e-Funds, are released after finalization of return. For example, electronic funds may be generated from an original form of payment, e.g., a debit or credit, gift card, cash, and so on, or a conversion between different forms of payment.

Returning to decision diamond 406, if a determination is made by the user of the store customer computing device 12 to decline the tender acknowledgement, then the method 400 proceeds to a set of steps that include processing of a store return by a store associate, instead of an automated return process, for example, in blocks 408-420.

More specifically, at block 422, the customer arrives at the store's return center location, for example, a customer service counter. At block 424, a store associate locates the return in the queue 210. At block 426, the return is processed at the return center location, for example, where the associate receives the returned item from the customer and uses a computer to process the return that includes a digital receipt confirmation or the like. At block 428, the inventory may be updated with the returned item, for example, the inventory management system 18 generates a record that reflects the updated inventory. Accordingly, a feature of an embodiment of the inventive concept is that if the item being returned meets certain criteria, e.g., unopened, non-produce, non-refrigerated, non-defective, etc., then the item will be returned to the store's inventory as a sellable product and can be returned to the sales floor once validation of the item has occurred.

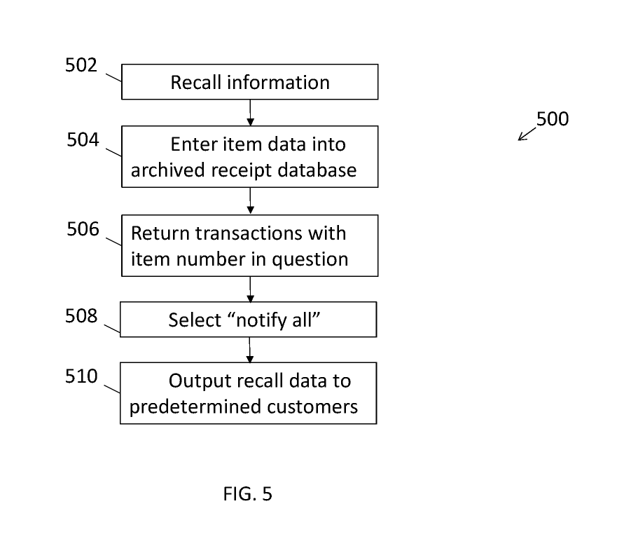

FIG. 5 is a flow diagram of a method 500 for processing recall notifications, in accordance with some embodiments. In describing the method 500, reference is also made to elements of FIGS. 1 and 2. For example, some or all of the method 500 can be governed by instructions that are stored in a computer hardware memory and can be executed by a computer hardware processor of one or more elements of the environment of FIG. 1.

At block 502, recall data on a particular item is received by a retail establishment, more specifically, by a vendor that sends recall data to a particular store, or store's corporate headquarters or the like.

At block 504, the retail establishment, for example, the store's headquarters, enters details on the notified recall into the archived receipt database of the customer portal 122. In the event of an item recall, a store associate may enter the item information which is processed by the recall processor 214, and in response generates a recall notification. The data repository 110 includes data that allows the recall processor 214 to compare the item number and date range to stored transaction information and output a notification to the customer device 12 during a predetermined recall time window to inform the customer that an item purchased has been recalled, and may include other relevant information, for example, includes steps on how to return the item.

At block 506, the archived receipt database returns all transactions with the item number submitted in block 504.

At block 508, a computer user, e.g., store associate, can use the store associate computing device 14 to select on a user interface display a “notify all” request, whereby at block 510, the recall processor 214 of the automated store item return system 106 receives from or accesses the archived receipt database the item transaction data generated in response to the received item number(s) and generates an electronic communication such as a text or email message to identified customers, more specifically, the computing devices 12 of customers who purchased the items along with instructions and/or other information on how to return the items.

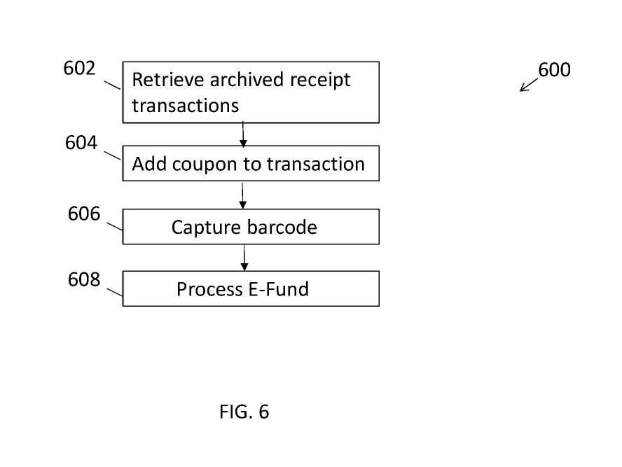

FIG. 6 is a flow diagram of a method 600 for processing missed coupons, in accordance with some embodiments. In describing the method 600, reference is also made to elements of FIGS. 1 and 2. For example, some or all of the method 600 can be governed by instructions that are stored in a computer hardware memory and can be executed by a computer hardware processor of one or more elements of the environment of FIG. 1, such as the coupon processor 218 described in FIG. 2.

At block 602, a listing of archived receipt transactions may be retrieved from the archived receipt database of the customer portal 122. The customer computing device 12 may include an application that is stored in a memory of the computing device 12, and when executed sends an electronic data request to retrieve the archived receipt transactions. In other embodiments, the store associate device 14 may perform this step.

At block 604, coupon data can be added to a field in an archived receipt transaction, for example, by the customer selecting an “add coupons” button or the like on a user interface that displays the option of entering coupon data.

At block 606, the application may activate a camera or other scanning device on the customer computing device 12 to capture a barcode or the like on the coupon of interest to be added to the retrieved receipt transaction. In other embodiments, the store associate device 14 may perform this step.

At block 608, funds are added to an electronic fund, for example, described in embodiments herein. For example, a customer may desire to add a coupon to a recent transaction. Here, the customer from a computing device 12 can select at a display a “Add My Coupons” feature. The customer may select a transaction that has been processed in a predetermined period, for example, the past 48 hours, then select “add coupons to this transaction” from the display. The customer may be prompted to scan the manufacture's coupon. After all coupons have been scanned or otherwise entered into and processed by the computing device 12, the customer may be prompted with a notification that that an electronic gift card or the like will be credited with the total cost savings. The system 106 may then compare the coupons to those on file to validate if the coupon scanned is valid. If the coupon is valid, then the eGift Card or the card may be credited and the customer may receive an alert letting them know that the coupons have been processed. If the coupon scanned is found to be fraudulent or not on file in the store, then the customer may receive a notification that includes relevant information.

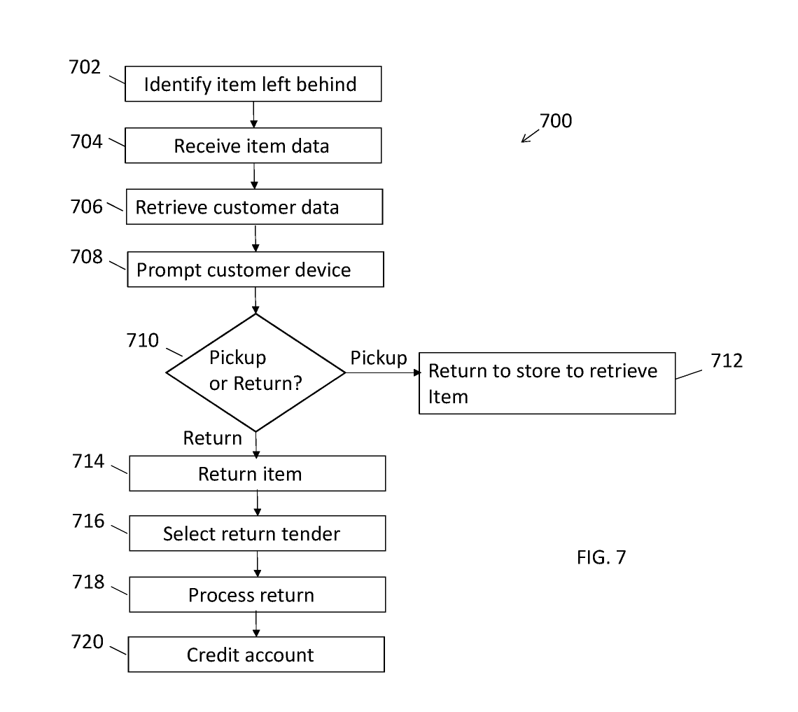

FIG. 7 is a flow diagram of a method 700 for processing a return corresponding to a purchased item left behind at a store, in accordance with some embodiments. In describing the method 700, reference is also made to elements of FIGS. 1 and 2. For example, some or all of the method 700 can be governed by instructions that are stored in a computer hardware memory and can be executed by a computer hardware processor of one or more elements of the environment of FIG. 1. The method 700 may apply to a missing bag or shopping items inadvertently left behind at the store, where the customer has the option of treating a purchased but missing store item as a returned item or to retrieve the missing store item.

At block 702, a store associate identifies items of interest that has been purchased or otherwise of interest to a customer but left behind at the store by the customer.

At block 704, a customer service agent or other store associate may input information regarding items left behind, such as date and time found, item descriptions, identification of store where the item was left behind, and so on. This information may be added to an archived receipt database, for example, stored at data repository 110.

At block 706, customer data may be retrieved from the data repository 110, such as customer information based on items purchased at the time and date in question, for example, within a particular timeframe such as 15 minutes.

At block 708, a computer prompt may be generated and output to the computing device that includes a request for confirmation regarding the missing bag or shopping items inadvertently left behind at the store, for example, a message stating “Please confirm that you are missing the following items:.” The listing of items following this message may be generated from the input data produced at block 704.

At decision diamond 710, the customer is given the option of returning to the store to retrieve the missing items to allow the items to be returned for credit. At block 712, the customer returns to the store to retrieve the missing items. At block 714, the customer elects to return the item. A computing device 12, 14 may be used to electronically process the return. For example, at block 716, a user can select a type of tender to be provided to the purchaser. In some embodiments, the type of tender may be the same tender used to make the purchase, for example, credit, debit, and so on. In other embodiments, a different type of tender may be provided. For example, in cases where the customer paid for an item in cash, the customer may receive a gift card when the item is returned. At block 718, the return is processed where a record is created by the system and stored at a store computer or other data repository, the item is returned to stock, or otherwise processed. At block 720, the customer's account is credited for the returned items.

As previously mentioned, a feature of the inventive concept is that the automated store item return system 106 may also be constructed and arranged to allow a customer to track an item of interest through a returns process as the item transitions from shipper to facility, as well as the process of verifying the returned item, and crediting the customer's account. In doing so, the authentication system 114 can operate to store data related to one of more of the methods for returning goods described in FIGS. 2-7 on a blockchain or related secure distributed computing system. For example, the authentication system 114 operates according to a peer-to-peer configuration for generating a blockchain comprising digitized content for authenticating store purchase data, archived records, and/or other data produced and described in one or more methods of FIGS. 3-7.

To achieve this, in some embodiments, the authentication system 114 includes a blockchain module 132 processing digitized content regarding a blockchain, for example, for authenticating return data.

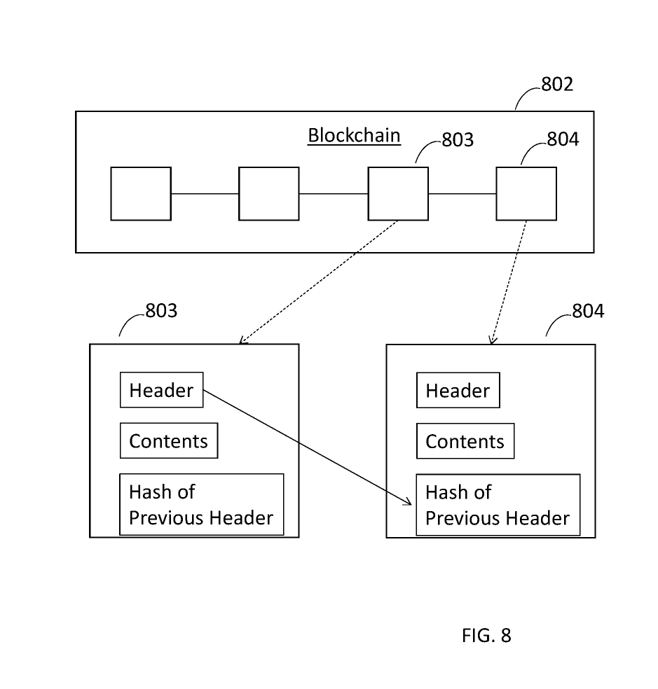

FIG. 8 depicts a blockchain 802 and two exemplary blocks 803, 804 of the blockchain, in accordance with some embodiments. Also referring to FIG. 1, embodiments of the blockchain 802 may be represent a publicly distributable transaction ledger or other distributed peer-to-peer network formed of a plurality of nodes 115, each maintaining an individual ledger for verifying a transaction, record data records, and so on according to a set of security procedures employing cryptographic methods. The distributable transaction ledger may be accessible by the authentication system 114 and/or automated store item return system 106 for verifying a transaction, completing a transaction, or viewing contents related to a transaction. In some embodiments, a decentralized ledger could be used for smart contracts, or self-executing contracts or the like, with respect to store returns. Here, a return-related contract can be converted to computer code, stored and replicated on the system, and controlled by the blockchain module 132.

The blockchain 802 may represent the publicly distributable transaction ledger of FIG. 1, in accordance with some embodiments. Each block, such as blocks 803, 804 may include data regarding recent transactions and/or contents relating to an archived store return, linking data that links one block 804 to a previous block 803 in the blockchain 802, proof-of-work data that ensures that the state of the blockchain 802 is valid and verified. The confirmed transactions of the blockchain 802 are performed using cryptography to ensure that the integrity of the blockchain 802 is enforced and can be independently verified by each node 115.

Embodiments of a block 803, 804 may include but not be limited to a header and contents. The header is used to link a block to other blocks in the blockchain 802. The contents may include transaction information relating to a return. A block, for example, block 804, may include a hash of the header of the previous block 803, thereby linking the blocks 803, 804.

In some embodiments, the blockchain module 132 may use a public key associated with the user's customer account or identity and received from the authentication system 114 along with a private key unique to the customer or other user and known only to the user and also received from the authentication system 114. The blockchain module 132 may use the public key and private key to gain access to the data, e.g., return information, stored on the blockchain 802. The private key may be used by the blockchain module 132 to generate a new transaction on the blockchain 802.

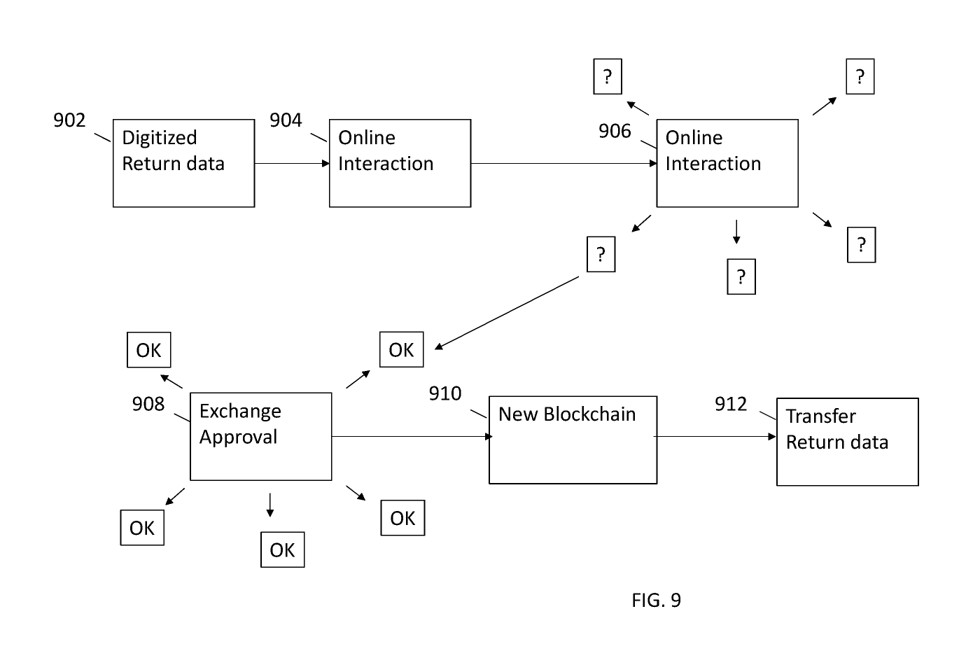

FIG. 9 is a flow diagram illustrating an operation that includes an authentication system 114 implementing a blockchain 802, in accordance with some embodiments. The authentication system 114 provides a peer-to-peer environment for digitized items that allow online interactions without going through a trusted intermediary such as a bank, credit-card company, social network, government, or other trusted third party.

Referring to FIG. 9, at step 902 an owner of an item for possible return desires to send information regarding an item of interest for return in a digitized form from a user's computing device 12, 14 to a destination, for example, a customer service representative. The information in digitized form may include digital cash such as bitcoin or the like, financial data, customer account information, and/or other sensitive information, which may be transmitted to a destination party without interception by a third party or trusted intermediary.

At step 904, an exchange between the parties is represented online as a block, and without participation of an intermediary. Here, the blockchain 802 shown in FIG. 8 may be implemented. At step 906, the peer-to-peer network timestamps actions regarding electronically stored documents, such as a transfer, access, modification, copying, merging, and/or other activities through which the digital content is used for its content as an item for trade, its content as a record to be verifiably maintained or changed, and/or as an item for remuneration. As shown in FIG. 8, this may be performed by hashing the foregoing into an ongoing chain of hash-based proof-of-work code to form a record that cannot be changed without redoing the proof-of-work. The block is broadcast to all parties in the network.

The longest chain distributed in step 906 provides that the data existed at the time to be provided for the hash. At step 908, the network, or more specifically, those in the network, approves the exchange as valid based on the longest block. At step 910, a new block is added, which provides a record of the transactions. A new chain is formed that now becomes the longest block. At step 912, the digitized content is moved to the receiving party at the destination identified in step 902.

The embodiments and examples set forth herein were presented in order to best explain the present invention and its practical application and to thereby enable those of ordinary skill in the art to make and use the invention. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the example embodiments have been described with reference to the components, modules and units discussed herein, such functional elements may be combined into fewer elements or separated into additional elements. Various combinations of optional features have been described herein, and it will be appreciated that described features may be combined in any suitable combination.

What is claimed is:

1. A method for processing store returns, comprising:
selecting, from a data repository, an electronically archived purchase receipt corresponding to an item for return to a retail establishment;
identifying the retail establishment for returning the purchased item regardless of whether the item was purchased at the retail establishment;
associating at the data repository the purchase receipt and a selected type of tender; and
electronically and automatically transferring a refund for the returned item to the selected type of tender.

2. The method of claim 1, wherein the type of tender includes an electronic gift card.

3. The method of claim 2, wherein the selected electronically archived purchase receipt is automatically processed to generate a credit that is directly applied to the electronic gift card.

4. The method of claim 1, wherein in response to identifying the retail establishment for returning the purchased item, determining whether to process the item for return at a location of the retail establishment or to pre-process the item prior to returning the item for return.

5. The method of claim 1, wherein the electronically archived purchase receipt is selected among a plurality of purchase receipts corresponding to item purchases made at one or more different retail establishments, and wherein the plurality of purchase receipts are linked at the data repository to a single customer account, and wherein each item purchase includes a purchase receipt uploaded to the single customer account.

6. The method of claim 5, wherein the refund includes a credit that is applied to the customer account.

7. The method of claim 1, wherein the data repository includes a customer electronic device interface for displaying return information on a customer computing device.

8. The method of claim 7, wherein the return information includes a listing of purchase receipts that includes the archived purchase receipt, which is selected from a user interface of the customer computing device.

9. The method of claim 1, wherein the data repository includes a store-specific return queue for storing a listing of returns predicted for receipt at the retail establishment during a predetermined period of time, which is accessible by a store associate computing device.

10. The method of claim 1, further comprising tracking the item for return as the item transitions from a shipping resource to the identified retail establishment.

11. The method of claim 1, further comprising:
identifying a storage locker for the item for return;
detecting by a sensor at the storage locker the presence of the item for return; and
automatically transferring the refund for the returned item to the selected type of tender in response to detecting the presence of the item for return at the storage locker.

12. The method of claim 1, further comprising securing data exchanged between the data repository and a user computing device by executing a peer-to-peer authentication system that generates a blockchain for the data.

13. The method of claim 1, wherein the item for return includes an item purchased at the retail establishment but left behind at the retail establishment, and wherein the method further comprises proving an option of returning or retrieving the item left behind at the retail establishment.

14. The method of claim 1, wherein the data repository stores a record that includes the electronically archived purchase receipt and a recall notification corresponding to the item.

15. A method for archiving purchase receipts, comprising:
purchasing an item;
generating an electronic record of the purchased item including a purchase receipt;
adding the electronic record to a customer account;
adding the purchase receipt to a plurality of electronically archived purchase receipts;
processing a return of the item by subsequently selecting the purchase receipt from the plurality of electronically archived purchase receipts.

16. The method of claim 15, wherein the item is purchased at a store, an e-commerce web site or marketplace, or an auction.

17. A system for returning store items, comprising:
a data repository
an automated store item return system that archives shopping receipts at the data repository for use for future customer-initiated returns of store items, consolidates store purchase data into a single customer account, the store purchase data include receipts for the store purchases and the type of purchase payment, and includes an interface for a user computing device to access the receipts from the customer account and generate a credit for a returned purchased item based on the accessed receipts; and
an authentication system that secures the accessed receipts exchanged between the user computing device and the automated store item return system.

18. The system of claim 17, further comprising a pickup locker processing system.

19. The system of claim 17, further comprising a mobile customer portal.
